(19) United States
(12) Patent Application Publication
(10) Pub. No.: US 2008/0062304 A1
(43) Pub. Date: Mar. 13, 2008

(54) Method and apparatus for displaying at least one video signal on at least one display

(76) Inventors: Claude Villeneuve, St-Hippolyte (CA); Ing. Marc Chagnon, Montreal (CA)

Correspondence Address: OGILVY RENAULT LLP, 1981 MCGILL COLLEGE AVENUE, SUITE 1600, MONTREAL, QC, H3A2Y3, US

(21) Appl. No.: 11/516,651

(22) Filed: Sep. 7, 2006

(51) Int. Cl. H04N 11/02

(52) U.S. Cl. 348/387.1

(57) ABSTRACT

According to a first aspect of the invention, there is provided a method for displaying at least one video signal on at least one display, the method comprising selecting at least one video signal to be displayed on the at least one display, providing, for each of the at least one selected video signal, at least one respective final display resolution and at least one respective target position on the at least one display, in at least one input unit, receiving a corresponding one of the selected at least one video signal, pre-scaling each of the corresponding one of the selected at least one video signal according to at least one respective intermediate display resolution compatible with said at least one respective final display resolution, in at least one output unit, post-scaling at least one pre-scaled video signal to obtain at least one post-scaled video signal at said at least one respective final display resolution, the selecting and pre-scaling enabling optimization of a bandwidth between the at least one input unit and the at least one output unit and displaying the at least one post-scaled video signal each at its the at least one respective target position on the at least one display.

### CROSS-REFERENCE TO RELATED APPLICATIONS

This is the first application filed for the present invention.

### TECHNICAL FIELD

This invention relates to the field of video signals. More precisely, this invention pertains to a method and apparatus for displaying at least one video signal on a at least one display.

### BACKGROUND OF THE INVENTION

It is very desirable to output a plurality of video signals on a plurality of displays. Unfortunately achieving this objective is very cumbersome, especially when large amount of video signals are involved.

Because the displays are now able to achieve great resolutions, a large plurality of video signals may be involved and required to be displayed.

Unfortunately, due to the bandwidth required by each video signals, the hardware required to display a large amount of signals on a plurality of displays is often very important and requires a lot of space which is a drawback. Moreover, such setting is not very flexible as the choice of having a given video signal on a given display is not easy to meet and may require many steps which lead to losses in productivity and competitiveness for operators.

There is a need for a method and apparatus that will overcome at least one of the above-identified drawbacks.

### SUMMARY OF THE INVENTION

According to a first aspect of the invention, there is provided a method for displaying at least one video signal on at least one display, the method comprising selecting at least one video signal to be displayed on the at least one display, providing, for each of the at least one selected video signal, at least one respective final display resolution and at least one respective target position on the at least one display, in at least one input unit, receiving a corresponding one of the selected at least one video signal, pre-scaling each of the corresponding one of the selected at least one video signal according to at least one respective intermediate display resolution compatible with said at least one respective final display resolution, in at least one output unit, post-scaling at least one pre-scaled video signal to obtain at least one post-scaled video signal at said at least one respective final display resolution, the selecting and pre-scaling enabling optimization of a bandwidth between the at least one input unit and the at least one output unit and displaying the at least one post-scaled video signal each at its the at least one respective target position on the at least one display.

According to another aspect of the invention, there is provided an apparatus for displaying at least one video signal on at least one display, the apparatus comprising a video signal selecting unit for selecting at least one video signal to be displayed on the at least one display for receiving, for each of the at least one video signal, at least one respective final display resolution and at least one respective target position on the at least one display, at least one input unit, each for receiving a corresponding one of the at least one video signal, each of the at least one input unit comprising a corresponding pre-scaling unit for pre-scaling each of the corresponding one of the at least one video signal according to at least one respective intermediate display resolution compatible with the at least one respective display resolution, at least one output unit, each for receiving a corresponding one of the at least one pre-scaled video signal, each of the at least one output unit comprising a corresponding post-scaling unit for post-scaling the corresponding one of the at least one pre-scaled video signal to obtain corresponding post-scaled video signals at the at least one respective final display resolution, each of the at least one output unit for providing the corresponding post-scaled video signals each at its at least one respective target position on a corresponding one of the at least one display, wherein the selecting in the video signal selecting unit and the pre-scaling in each of the at least one input unit enables an optimization of bandwidth between the at least one input unit and the at least one output unit.

### BRIEF DESCRIPTION OF THE DRAWINGS

Further features and advantages of the present invention will become apparent from the following detailed description, taken in combination with the appended drawings, in which:

FIG. 1 is a block diagram which shows an embodiment of the apparatus for displaying video signals on at least one display; the apparatus comprises at least one input unit, a video signal selecting unit and at least one output unit;

FIG. 2 is a block diagram which shows an embodiment of an input unit; the input unit comprises at least one de-serial or decoder module and a pre-scaled signal providing unit;

FIG. 3 is a block diagram which shows an embodiment of a pre-scaled signal providing unit; in this embodiment, the pre-scaled signal providing unit comprises at least one video signal pre-scaler and at least one outputting unit;

FIG. 4 is a block diagram which shows an embodiment of a video signal pre-scaler; the video signal pre-scaler comprises a vertical pre-scaler module comprising at least one vertical pre-scaler and an horizontal pre-scaler module comprising at least one horizontal pre-scaler;

FIG. 5 is a block diagram which shows an embodiment of an output selector;

FIG. 6 is a block diagram which shows an embodiment of the output unit; the output unit comprises, inter alia, an input unit combiner and a resizer;

FIG. 7 is a block diagram which shows an embodiment of the input unit combiner of the output unit;

FIG. 8 is a block diagram which shows an embodiment of the resizer of the output unit;

FIG. 9 is a flow chart which shows how an apparatus for displaying at least one video signal on a given display operates according to one embodiment; according to a first step, at least one video signal to be displayed is selected, according to a second step, at least one respective final display resolution and at least one respective target position on the display is provided, according to a third step, each of the selected at least one video signal is pre-scaled according to at least one respective intermediate display resolution; according to a fourth step, each of the pre-scaled video signals is post-scaled in order to obtain post-scaled video signals and according to a fifth step, the post-scaled video signal is displayed;

FIG. 10 is a flow chart which shows how the at least one video signal to be displayed is selected according to one embodiment;

FIG. 11 is a flow chart which shows how a respective final display resolution and a respective target position on the display are provided according to one embodiment;

FIG. 12 is a flow chart which shows how each of the selected video signals is pre-scaled according to at least one respective intermediate display resolution;

FIG. 13 is a flow chart which shows how each of the pre-scaled video signals is post-scaled in order to obtain post-scaled video signals; and

FIG. 14 is a flow chart which shows how the post-scaled video signals are displayed each at their respective target position.

It will be noted that throughout the appended drawings, like features are identified by like reference numerals.

### DETAILED DESCRIPTION OF THE PREFERRED EMBODIMENT

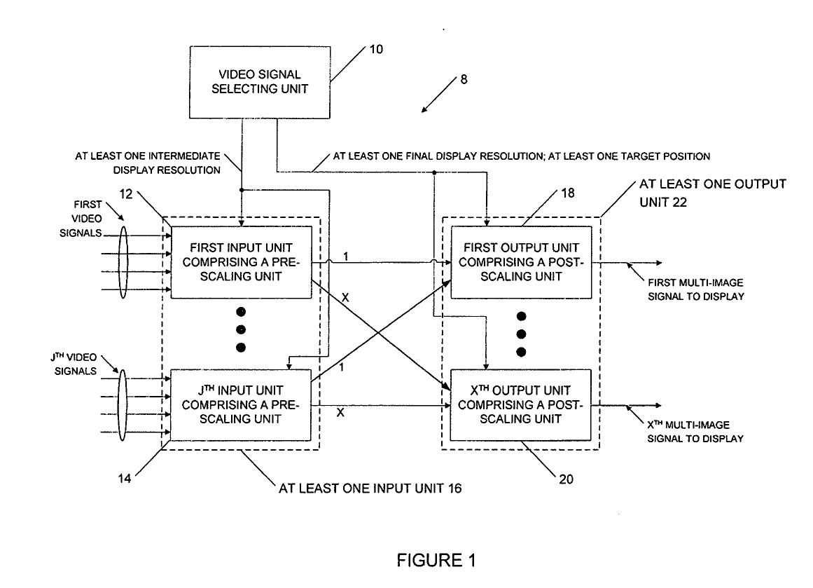

Now referring to FIG. 1, there is shown an embodiment of an apparatus for displaying at least one video signal on at least one display 8.

The apparatus 8 comprises a video signal selecting unit 10, at least one input unit comprising a pre-scaling unit 16 and at least one output unit comprising a post-scaling unit 22.

In the embodiment disclosed in FIG. 1, the at least one input unit comprising a pre-scaling unit 16 comprises a first input unit comprising a pre-scaling unit 12, . . . and a J^{th} input unit comprising a pre-scaling unit 14. Still in this embodiment, the at least one output unit comprising a post-scaling unit 22 comprises a first output unit comprising a post-scaling unit 18, . . . and a X^{th} output unit comprising a post-scaling unit 20.

The video signal selecting unit 10 is used to provide at least one intermediate display resolution, at least one final display resolution and at least one target position. More precisely, the at least one intermediate display resolution is provided to at least one input unit comprising a pre-scaling unit of the at least one input unit comprising a pre-scaling unit 16 while the at least one final display resolution and the at least one target position are provided to at least one output unit comprising a post-scaling unit of the at least one output unit comprising a post-scaling unit 22.

The first input unit comprising a pre-scaling unit 12 receives a first at least one video signal, performs a pre-scaling of the first at least one received video signal and provides a corresponding at least one pre-scaled video signal. The pre-scaling of the first at least one received video signal is performed according to at least one corresponding intermediate display resolution provided by the video signal selecting unit 10. Similarly, the J^{th} input unit comprising a pre-scaling unit 14 receives a J^{th} at least one video signal, performs a pre-scaling of the J^{th} at least one received video signals and provides a corresponding at least one pre-scaled video signal.

The first output unit comprising a post-scaling unit 18 receives at least one pre-scaled video signal. The at least one pre-scaled video signal comprises a first pre-scaled video signal provided by the first input unit comprising a pre-scaling unit 12, . . . and a J^{th} pre-scaled video signal provided by the J^{th} input unit comprising a pre-scaling unit 14. The first output unit comprising a post-scaling unit 18 further receives at least one final display resolution and at least one target position and provides a first multi-image signal to display. It will be appreciated that the first multi-image signal to display may be displayed on displays not shown in the drawings.

Similarly, the X^{th} output unit comprising a post-scaling unit 20 receives a X^{th} at least one pre-scaled video signal. The X^{th} at least one pre-scaled video signal comprises a first pre-scaled video signal provided by the first input unit comprising a pre-scaling unit 12, . . . and a J^{th} pre-scaled video signal provided by the J^{th} input unit comprising a pre-scaling unit 14. The X^{th} output unit comprising a post-scaling unit 20 further receives at least one final display resolution and at least one target position and provides a X^{th} multi-image signal to display.

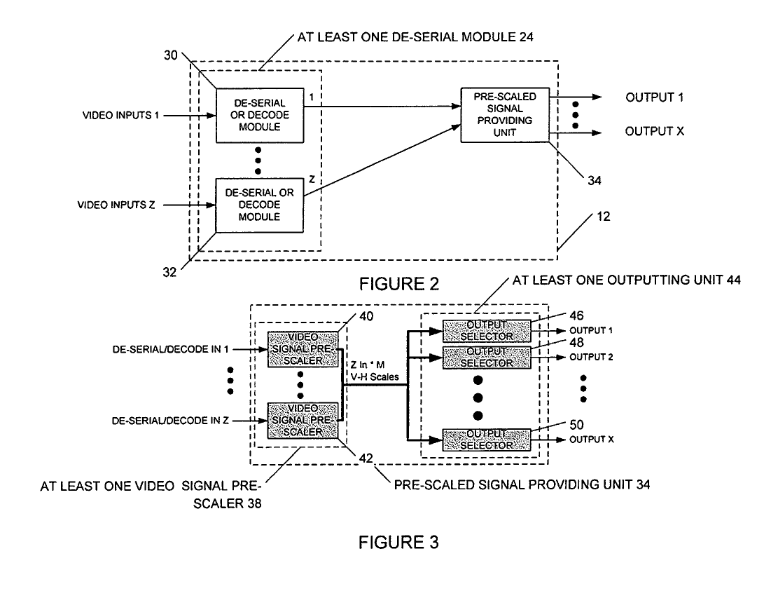

Now referring to FIG. 2, there is shown an embodiment of the first input unit comprising a pre-scaling unit 12. More precisely, the unit 12 comprises at least one de-serial or decode modules 24 and a pre-scaled signal providing unit 34. In the embodiment disclosed, the at least one de-serial or decode modules 24 comprises a first de-serial or decode module 30 . . . and a Z^{th} de-serial or decode module 32.

In the embodiment shown in FIG. 2, the first de-serial or decode module 30 receives video input signal 1. The first de-serial or decode module 30 performs a de-serialization or a decoding of the received video input signal 1 and provides a first corresponding de-serialized or decoded signal. The first corresponding de-serialized or decoded signal is provided to the pre-scaled signal providing unit 34.

The Z^{th} de-serial or decode module 32 receives video input signal Z and performs a de-serialization or decoding of the received video input signal Z. The Z^{th} de-serial or decode module 32 performs a de-serialization or decoding of the received signal and provides a Z^{th} corresponding de-serialized or decoded signal. The Z^{th} corresponding de-serialized or decoded signal is provided to the pre-scaled signal providing unit 34.

Now referring to FIG. 3, there is shown an embodiment of the pre-scaled signal providing unit 34. The pre-scaled signal providing unit 34 comprises at least one video signal pre-scaler 38 and at least one outputting unit 44. The at least one video signal pre-scaler 38 comprises video signal pre-scaler 40, . . . and video signal pre-scaler 42. The at least one outputting unit 44 comprises output selector 46, output selector 48, . . . and output selector 50. Each of the at least one video signal pre-scaler 38 receives a corresponding de-serialized or decoded signal and provides M corresponding pre-scaled signals which are provided each to a corresponding outputting unit of the at least one outputting unit 44.

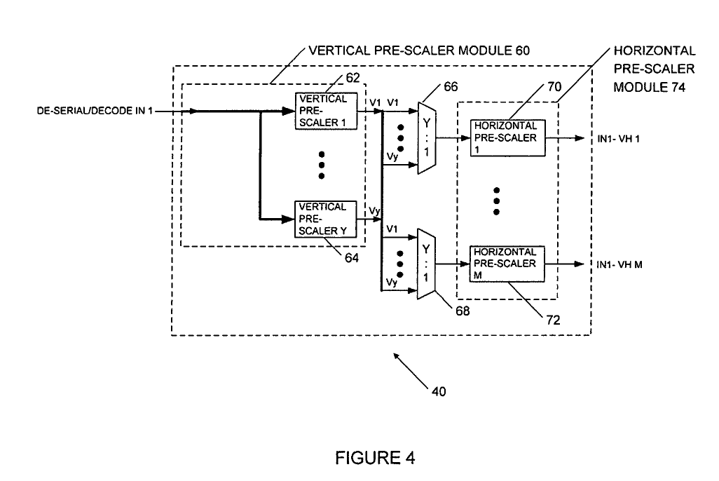

Now referring to FIG. 4, there is shown an embodiment of the video signal pre-scaler 40.

The video signal pre-scaler 40 comprises a vertical pre-scaler module 60 and an horizontal pre-scaler module 74. The vertical pre-scaler module 60 is used for performing at least one pre-scaling in a vertical direction while the horizontal pre-scaler module 74 is used for performing at least one pre-scaling in an horizontal direction.

More precisely, the vertical pre-scaler module 60 comprises at least one vertical pre-scaler such as vertical pre-scaler 1 62 and vertical pre-scaler y 64. Each of the at least one vertical pre-scaler is used to perform a pre-scaling in a vertical direction according to a given factor.

The horizontal pre-scaler module 74 comprises at least one horizontal pre-scaler such as horizontal pre-scaler 1 70 and horizontal pre-scaler M 72. Each of the at least one horizontal pre-scaler is used to perform a pre-scaling in an horizontal direction according to a given factor.

The skilled addressee will appreciate that the pre-scaling in an horizontal direction is independent from the pre-scaling in a vertical direction. Also, a corresponding pre-scaling in the horizontal direction and a corresponding pre-scaling in the vertical direction are assigned to each signal.

The video signal pre-scaler 40 further comprises multiplexers 66 and 68 which are used for providing at least one of a vertically pre-scaled signal to one of the horizontal pre-scaler to therefore create a combination of a pre-scaling in an horizontal direction with a pre-scaling in a vertical direction.

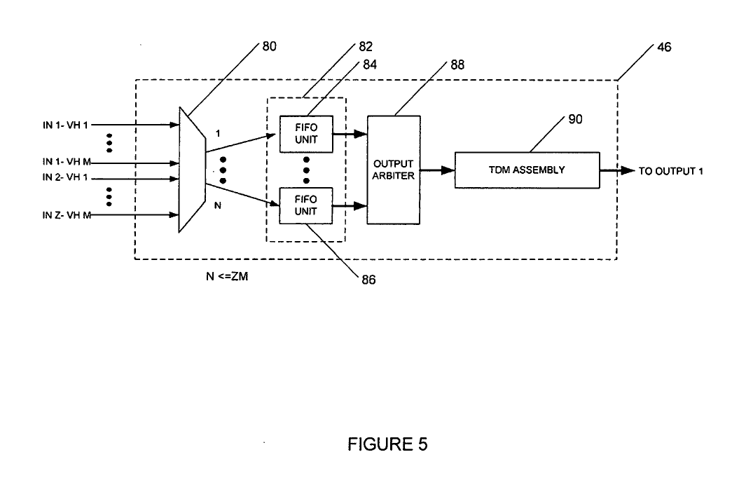

Now referring to FIG. 5, there is shown an embodiment of an output selector 46 such as one selected from the at least one outputting unit 44.

The output selector 46 is used to act as a filter that will keep only the data of the scaled images that have been selected to be used for display.

In this embodiment, the output selector 46 comprises a selector 80, at least one First In First Out unit (FIFO) 82, an output arbiter 88 and a Time Division Multiplexer (TDM) assembly 90. The at least one First In First Out unit (FIFO) 82 comprises FIFO unit 84, . . . and FIFO unit 86.

The selector 80 is used to select N signals from incoming signals. Each of the N selected signals is provided to a corresponding First In First Out unit of the at least one First In First Out unit 82. Each First In First Out unit of at least one First In First Out unit 82 provides a corresponding signal to the output arbiter 84, used for reading data and provided the data to the TDM assembly 90 which generates time-multiplexed data elements representative of the data pre-scaled.

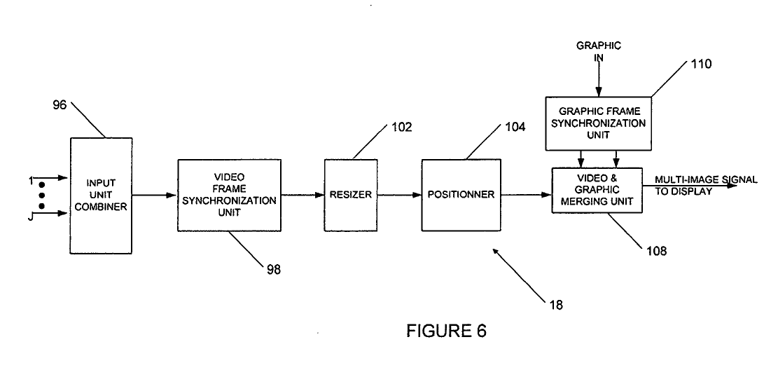

Now referring to FIG. 6, there is shown an embodiment of the first output unit comprising a post-scaling unit 18.

The unit 18 comprises an input unit combiner 96, a video frame synchronization unit 98, a resizer 102, a positioner 104, a graphic frame synchronization unit 110 and a video and graphics merging unit 108.

The input unit combiner 96 receives each of the at least one pre-scaled video signal, combines each of the at least one pre-scaled video signal and provides a combined signal to the video frame synchronization unit 98.

The video frame synchronization unit 98 receives the combined signal and performs a frame synchronization on the combined signal to provide a frame-synchronized signal.

The frame-synchronized signal is provided to a resizer 102 which performs a resizing of the frame-synchronized signal to provide a resized signal.

The resized signal is provided to the positioner 104. The positioner 104 performs a positioning of the resized signal and provides a positioned signal to the video and graphic merging unit 108 which further receives data originating from the graphics frame synchronizing unit 110. The video and graphic merging unit 108 performs a merging of the positioned signal and of the data originating from the graphics frame synchronizing unit 110 to provide a multi-image signal to display.

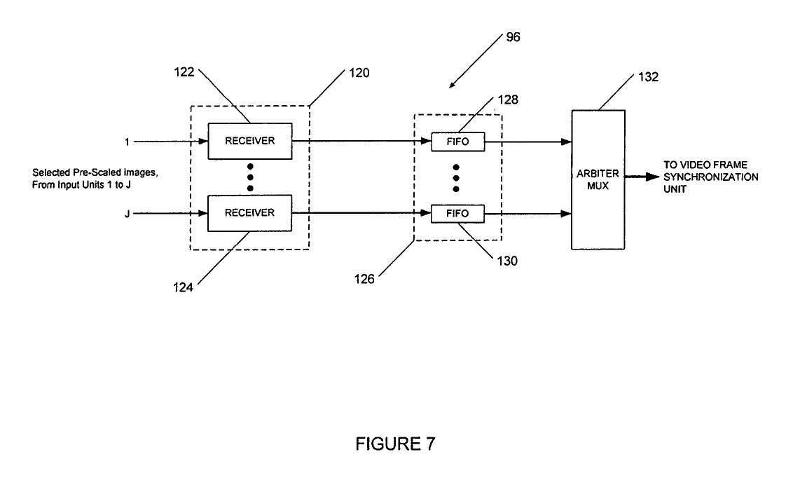

Now referring to FIG. 7, there is shown an embodiment of the input unit combiner 96. In this embodiment, the input unit combiner 96 comprises at least one receiver 120, at least one First In First Out unit 126 and an arbiter multiplexer 132.

The at least one receiver 120 comprises receiver 122, . . . and receiver 124.

The at least one First In First Out unit 126 comprises First In First Out unit 128, . . . and First In First Out unit 130.

Each of the at least one receiver 120 receives a corresponding selected pre-scaled signal and provides corresponding signals to a corresponding First In First Out unit of the at least one First In First Out unit 126. The corresponding output signal of each of the at least one First In First Out unit 126 is provided to arbiter multiplexer 132. The arbiter multiplexer 132 receives the corresponding output signal of each of the at least one of First In First Out unit 126 and aggregates the received corresponding at least one signal to provide a signal which is provided to the video frame synchronizing unit 98.

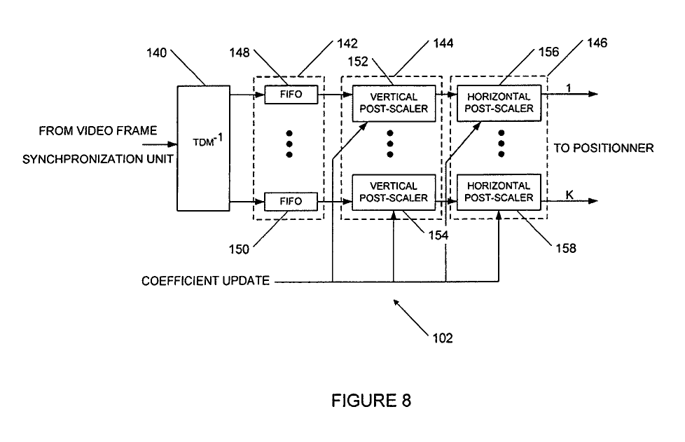

Now referring to FIG. 8, there is shown an embodiment of the resizer 102.

The resizer 102 disclosed comprises an inverse Time Division Multiplexing (TDM) unit 140, at least one First In First Out unit 142, at least one vertical post-scaler 144 and at least one horizontal post-scaler 146.

The at least one First In First Out unit 142 comprises First In First Out unit 148, . . . and First In First Out units 150. The at least one vertical post-scaler 144 comprises vertical post-scaler 152, . . . and vertical post-scaler 154. The at least one horizontal post-scaler 146 comprises horizontal post-scaler 156, . . . and horizontal post-scaler 158.

The inverse Time Division Multiplexing (TDM) unit 140 receives a signal from the video frame synchronizer unit 98, performs a TDM demultiplexing of the signal and provides at least one corresponding demultiplexed signal, each of which is provided to a corresponding First In First Out unit of the at least one First In First Out unit 142.

Each of the at least one First In First Out unit 142 provides a corresponding signal which is provided to a corresponding one of the at least one vertical post-scaler 144. Each of the at least one vertical post-scaler 144 performs a vertical post-scaling of the corresponding at least one signal and provides a corresponding vertically post-scaled signal.

Each corresponding vertically post-scaled signal is provided to a corresponding horizontal post-scaler of the at least one horizontal post-scaler 146.

Each horizontal post-scaler of the at least one horizontal post-scaler 146 provides an horizontally post-scaled signal which is provided to the positioner 104.

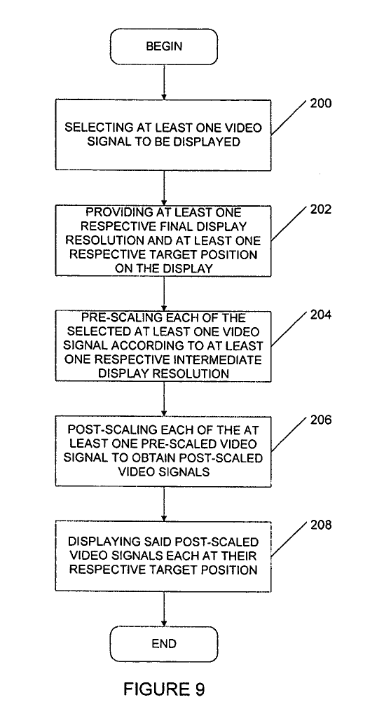

Now referring to FIG. 9, there is shown an embodiment for displaying at least one video signal on at least one given display.

According to step 200, at least one video signal to be displayed is selected.

According to step 202, at least one respective final display resolution and at least one respective target position on the display are provided. The at least one respective final display resolution and the at least one respective target position are provided for each of the at least one video signal.

According to step 204, each of the selected at least one video signal is pre-scaled according to a at least one respective intermediate display resolution.

According to step 206, each of the at least one pre-scaled video signal is post-scaled in order to obtain at least one post-scaled video signal.

According to step 208, the at least one post-scaled video signal is displayed each at their respective target position on the display.

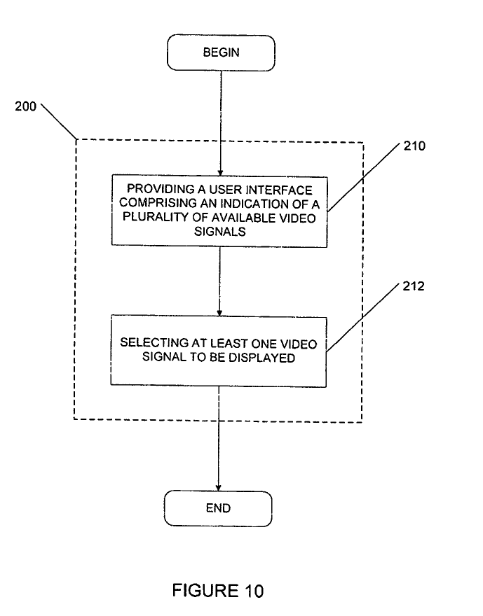

Now referring to FIG. 10, there is shown an embodiment for selecting the at least one video signal to be displayed.

According to step 210, a user interface comprising an indication of a plurality of available video signals is provided. In one embodiment, the user interface is provided to an operator via a control screen. The user interface may be provided in response to the installation of a software for instance.

According to step 212, at least one video signal to be displayed is selected. In one embodiment, the at least one video signal to be displayed is selected by an operator. Alternatively, the at least one video signal to be displayed is selected automatically using a configuration file.

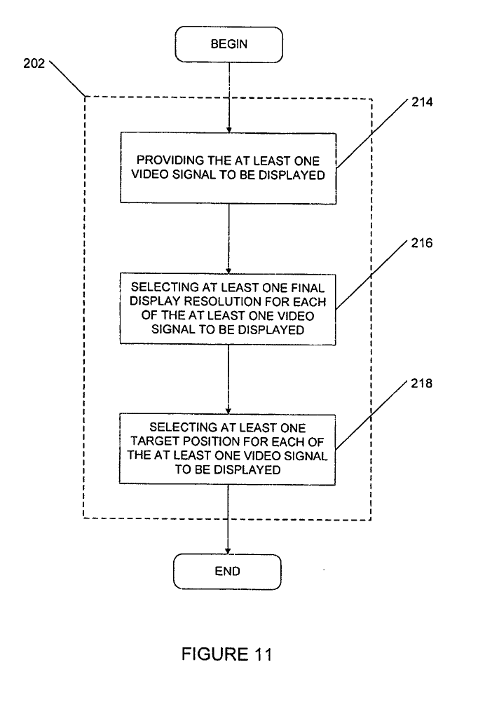

Now referring to FIG. 11, there is shown an embodiment for providing the at least one respective final display resolution and the at least one respective target position on the display.

According to step 214, the at least one video signal to be displayed is provided. In one embodiment, the at least one video signal to be displayed is provided to the operator.

According to step 216, at least one final display resolution is selected for each of the at least one video signal to be displayed. In one embodiment, the at least one final display resolution is automatically selected using a configuration file. Alternatively, the at least one final display resolution is selected by the operator according to desired requirements.

According to step 218, at least one target position is selected for each of the at least one video signal to be displayed. In one embodiment, the at least one target position of the video signal to be displayed is automatically selected using a configuration file. Alternatively, the at least one target position for each of the video signal to be displayed is selected by the operator according to specific requirements. It will be appreciated by the skilled addressee that various methods may be used for enabling the operator to select the at least one final display resolution and the at least one target position of the video signal based on the user interface provided.

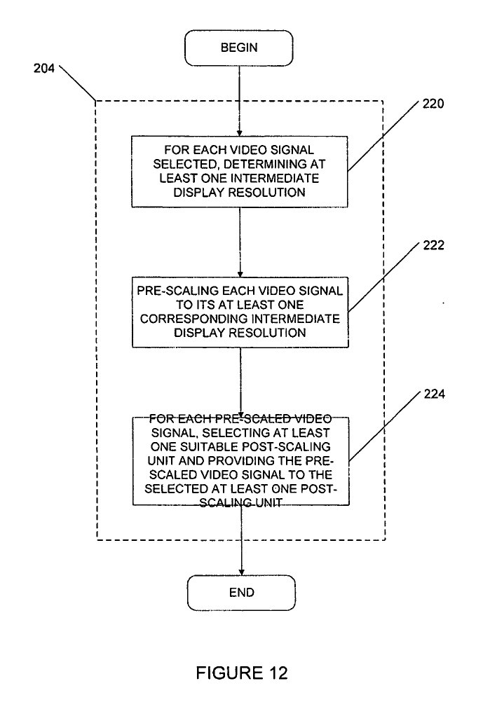

Now referring to FIG. 12, there is shown an embodiment for pre-scaling each of the at least one selected video signal according to at least one respective intermediate display resolution.

According to step 220, at least one intermediate display resolution is selected for each of the at least one video signal selected.

In one embodiment, the at least one intermediate display resolution, obtained through pre-scaling, is selected according to a principle. More precisely, the principle is that up-scaling should be avoided after a pre-scaling.

The skilled addressee will appreciate that the determining of the at least one intermediate display resolution is achieved in order to reduce the bandwidth between an input unit performing a pre-scaling and an output unit performing a post-scaling. Such reducing advantageously enables a device to select among a large plurality of video signals to display.

According to step 222, each video signal is pre-scaled according to its corresponding at least one intermediate resolution. The skilled addressee will appreciate that various methods may be used to pre-scale the at least one video signal to its at least one corresponding intermediate display resolution.

According to step 224, at least one suitable post-scaling unit is selected for each of at least one pre-scaled video signal and the at least one pre-scaled video signal is provided to the selected at least one post-scaling unit. It will be appreciated that preferably each post-scaling unit is dedicated to a given display unit.

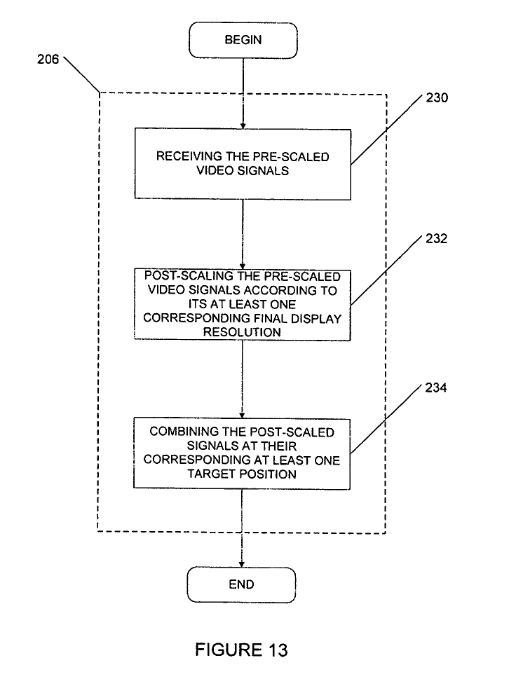

Now referring to FIG. 13, there is shown an embodiment for post-scaling each of the at least one pre-scaled video signal in order to obtain the at least one post-scaled video signal.

According to step 230, the at least one pre-scaled video signal is received.

According to step 232, the at least one pre-scaled video signal is post-scaled according to at least one corresponding final display resolution.

According to step 234, the at least one post-scaled video signal is combined at its corresponding at least one target position. The at least one post-scaled video signal is combined to provide a signal to display.

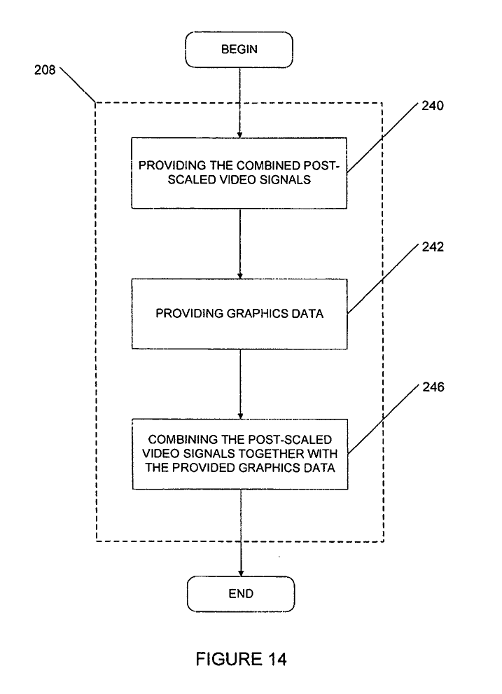

Now referring to FIG. 14, there is shown an embodiment for displaying the at least one post-scaled video signal.

According to step 240, the at least one post-scaled video signals is provided.

According to step 242, graphics data are provided. In one embodiment, graphics data are provided by the operator. Alternatively graphics data may be provided automatically according to a configuration file. It will be appreciated that graphics data may comprise various elements such as a time counter to display, moving bars to display, logos to display, or the like. It will be appreciated that graphics data is primarily used for adding a value to the user interface displaying the at least one post-scaled video signal.

According to step 246, the at least one post-scaled video signal is combined together with the provided graphics data.

Now referring back to FIG. 1, the skilled addressee will appreciate that since a pre-scaling is performed at each of at least one input unit, it is possible to handle simultaneously a large number of incoming video signals as an optimization of the bandwidth is achieved. Also the skilled addressee will appreciate that many output units may be used each for providing at least one corresponding signal to display in accordance with a selection performed using the video signal selecting unit 10.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, a computer readable medium or an electrical or electro-magnetical signal.

The embodiments of the invention described above are intended to be exemplary only. The scope of the invention is therefore intended to be limited solely by the scope of the appended claims.

I claim:

1. A method for displaying at least one video signal on at least one display, said method comprising:
selecting at least one video signal to be displayed on the at least one display;
providing, for each of said at least one selected video signal, at least one respective final display resolution and at least one respective target position on the at least one display;
in at least one input unit, receiving a corresponding one of the selected at least one video signal, pre-scaling each of said corresponding one of the selected at least one video signal according to at least one respective intermediate display resolution compatible with said at least one respective final display resolution;
in at least one output unit, post-scaling at least one pre-scaled video signal to obtain at least one post-scaled video signal at said at least one respective final display resolution;
said selecting and pre-scaling enabling optimization of a bandwidth between said at least one input unit and said at least one output unit; and
displaying said at least one post-scaled video signal each at its said at least one respective target position on said at least one display.

2. The method as claimed in claim 1, wherein said pre-scaling comprises performing at least one vertical pre-scaling and at least one horizontal pre-scaling of each of said corresponding one of the selected at least one video signal.

3. The method as claimed in claim 1, wherein said post-scaling comprises performing at least one vertical post-scaling and at least one horizontal post-scaling of said at least one pre-scaled video signal.

4. The method as claimed in claim 1, further comprising providing graphics data, further wherein said displaying of said at least one post-scaled video signal each at its said at least one respective target position on said at least one display comprises combining the at least one post-scaled video signal with the provided graphics data.

5. An apparatus for displaying at least one video signal on at least one display, said apparatus comprising:
a video signal selecting unit for selecting at least one video signal to be displayed on the at least one display and for receiving, for each of said at least one video signal, at least one respective final display resolution and at least one respective target position on the at least one display;
at least one input unit, each for receiving a corresponding one of the at least one video signal, each of the at least one input unit comprising a corresponding pre-scaling unit for pre-scaling each of the corresponding one of the at least one video signal according to at least one respective intermediate display resolution compatible with said at least one respective display resolution;
at least one output unit, each for receiving a corresponding one of the at least one pre-scaled video signal, each of the at least one output unit comprising a corresponding post-scaling unit for post-scaling the corresponding one of the at least one pre-scaled video signal to obtain corresponding post-scaled video signals at said at least one respective final display resolution, each of said at least one output unit for providing said corresponding post-scaled video signals each at its said at least one respective target position on a corresponding one of the at least one display;
wherein said selecting in said video signal selecting unit and said pre-scaling in each of said at least one input unit enables an optimization of bandwidth between said at least one input unit and said at least one output unit.

6. The apparatus as claimed in claim 5, wherein said apparatus comprises a plurality of input units and a plurality of output units.

7. The apparatus as claimed in claim 5, wherein said apparatus comprises one input unit.

8. The apparatus as claimed in claim 5, wherein said apparatus comprises one output unit.

9. The apparatus as claimed in claim 5, wherein each of said at least one input unit further comprises at least one de-serial or decode module for receiving said corresponding one of the at least one video signal and for providing de-serialized or decoded video signal to said corresponding pre-scaling unit.

10. The apparatus as claimed in claim 9, wherein each of said corresponding pre-scaling unit comprises at least one pre-scaler, further wherein each of said at least one pre-scaler receives a corresponding one of the de-serialized or decoded video signals and performs at least one corresponding pre-scaling.

11. The apparatus as claimed in claim 10, wherein each of said at least one pre-scaler comprises at least one vertical pre-scaler for performing a vertical pre-scaling and at least one horizontal pre-scaler for performing an horizontal pre-scaling.

12. The apparatus as claimed in claim 5, wherein said corresponding post-scaling unit comprises at least one vertical pre-scaler for performing at least one vertical pre-scaling and at least one horizontal pre-scaler for performing at least one horizontal pre-scaling.
